(19) United States
(12) Patent Application Publication
(10) Pub. No.: US 2025/0217087 A1
(43) Pub. Date: Jul. 3, 2025

(54) WATCHING SYSTEM, PRINTING APPARATUS, AND METHOD OF CONTROLLING PRINTING APPARATUS

(71) Applicant: SEIKO EPSON CORPORATION, TOKYO (JP)

(72) Inventor: Katsuichi YOSHIDA, MATSUMOTO-SHI (JP)

(21) Appl. No.: 19/002,792

(22) Filed: Dec. 27, 2024

(30) Foreign Application Priority Data
Dec. 27, 2023 (JP) 2023-220613

(51) Int. Cl. G06F 3/12

(52) U.S. Cl. CPC G06F 3/1238; G06F 3/1288

(57) ABSTRACT

A watching system is a notification system including a first server, a printing apparatus, and an information processing apparatus. The printing apparatus is capable of transmitting detection information based on a user operation to the first server after printing print information. The first server is capable of transmitting a notification to the information processing apparatus based on the received detection information.

The present application is based on, and claims priority from JP Application Serial Number 2023-220613, filed Dec. 27, 2023, the disclosure of which is hereby incorporated by reference herein in its entirety.

### BACKGROUND

### 1. Technical Field

The present disclosure relates to a watching system, a printing apparatus, and a method of controlling a printing apparatus.

### 2. Related Art

As described in JP-A-2004-272568, a system is known in which a watching apparatus is installed in a house of a person to be watched over and the person to be watched over is remotely watched over via a network.

The above-described system may not be able to cope with the daily life of the person to be watched over, further requires a dedicated apparatus, and thus is not convenient.

### SUMMARY

A watching system includes a first server, a printing apparatus, and an information processing apparatus. The printing apparatus is capable of transmitting detection information based on a user operation to the first server after printing print information, and the first server is capable of transmitting a notification to the information processing apparatus based on the received detection information.

A printing apparatus is capable of communicating with a first server and includes a printing section that prints print information, a detecting section that performs detection based on a user operation, and a control section that, after the printing of the print information by the printing section, is capable of generating detection information based on the detection by the detecting section and transmitting the detection information to the first server.

A method of controlling a printing apparatus that is capable of communicating with a first server and includes a printing section that prints print information and a detecting section that performs detection based on a user operation includes, after the printing of the print information by the printing section, generating detection information based on the detection by the detecting section and transmitting the detection information to the first server.

### BRIEF DESCRIPTION OF THE DRAWINGS

FIG. 1 is a block diagram illustrating a configuration of a notification system.

FIG. 2 is a state transition diagram illustrating a method of controlling the notification system.

FIG. 3 is a flowchart illustrating a method of controlling a printing apparatus when a first sensor is used.

FIG. 4 is a flowchart illustrating a method of controlling the printing apparatus when a second sensor is used.

### DESCRIPTION OF EMBODIMENTS

### 1. Notification System and Configuration of Printing Apparatus

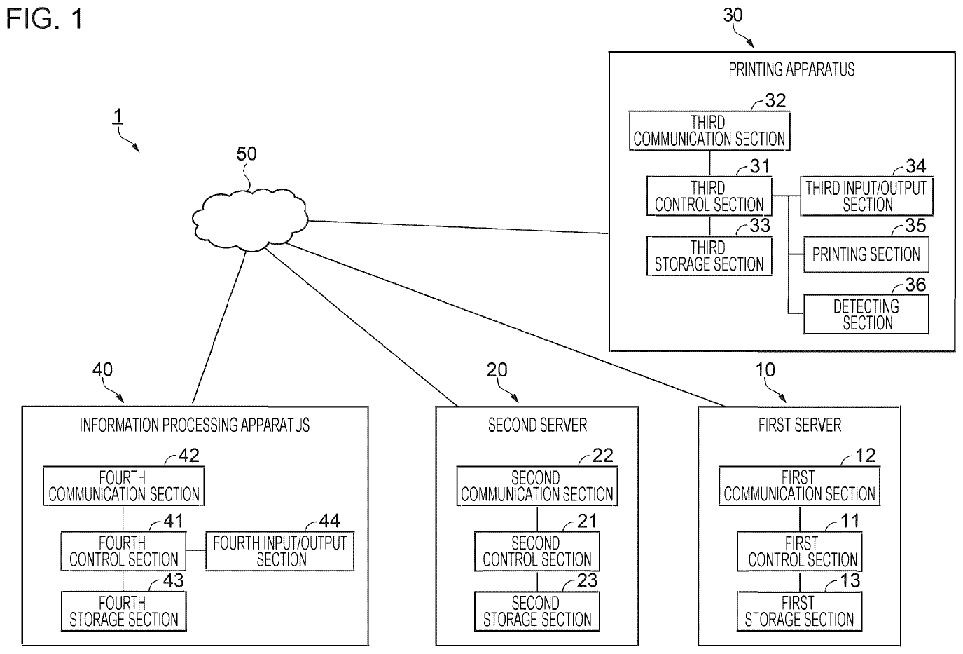

A notification system 1 illustrated in FIG. 1 is a watching system according to an embodiment and includes at least a first server 10, a printing apparatus 30, and an information processing apparatus 40. As illustrated in FIG. 1, the notification system 1 may include a second server 20. In the following description, it is assumed that the notification system 1 includes the second server 20.

For example, a management company that manages the first server 10 provides a notification service which is a watching service for watching over a person to be watched over, such as an elderly person. The printing apparatus 30 is installed in a house of the person to be watched over, such as an elderly person and is used for the daily life of the person to be watched over. The information processing apparatus 40 is a smart device, a tablet terminal, a computer, or the like of a client who has requested the watching service for watching over the person to be watched over from the management company that manages the first server 10.

The first server 10 transmits a notification to the information processing apparatus 40 based on detection information of the printing apparatus 30. From the notification received by the information processing apparatus 40, the client can know the behavior state of the person to be watched over who is at a remote location and uses the printing apparatus 30.

The first server 10, the second server 20, the printing apparatus 30, and the information processing apparatus 40 can communicate with each other via, for example, a wide area network (WAN) 50 such as the Internet. The WAN 50 may include a network such as a local area network (LAN).

For example, unique Internet Protocol (IP) addresses are assigned to the first server 10, the second server 20, the printing apparatus 30, and the information processing apparatus 40. The first server 10, the second server 20, the printing apparatus 30, and the information processing apparatus 40 can specify an IP address assigned to a communication destination and communicate with the communication destination. In addition, the first server 10, the second server 20, the printing apparatus 30, and the information processing apparatus 40 may specify a detailed location such as a directory or a file of a transmission destination by using a uniform resource locator (URL) and transmit information to the transmission destination.

The first server 10 is a server that serves the printing apparatus 30 and the information processing apparatus 40 as clients. The first server 10 includes a first control section 11, a first communication section 12, and a first storage section 13.

The first control section 11 comprehensively controls each of the sections of the first server 10. The first control section 11 includes a central processing unit (CPU), a universal asynchronous receiver transmitter (UART) that manages input and output, a field programmable gate array (FPGA) or a programmable logic device (PLD) that is a logic circuit, and the like. The CPU is also referred to as a processor.

The first storage section 13 includes memory such as flash read only memory (ROM) or a hard disk drive (HDD) that is rewritable nonvolatile memory, and random access memory (RAM) that is volatile memory.

The CPU of the first control section 11 reads a program

stored in the nonvolatile memory of the first storage section 13 and executes the program by using the RAM of the first storage section 13 as a work area.

For example, a program for transmitting the notification to the information processing apparatus 40 based on the received detection information of the printing apparatus 30 is stored in the first storage section 13 and can be executed by the first control section 11 as described later.

The first communication section 12 of the first server

10 includes a circuit that can perform wireless or wired communication. The first communication section 12 includes an antenna when the circuit can perform wireless communication. The first communication section 12 includes a connector when the circuit can perform wired communication.

The first communication section 12 can perform communication via the WAN 50. The first server 10 transmits and receives data to and from the communication destination via the first communication section 12, but the description of the transmission and the reception via the first communication section 12 will be omitted in the following description for the sake of simplicity. The same applies to a second communication section 22 of the second server 20, a third communication section 32 of the printing apparatus 30, and a fourth communication section 42 of the information processing apparatus 40, which will be described later.

The printing apparatus 30 is a client that uses the first server 10 and the second server 20 as servers for the printing apparatus 30. The printing apparatus 30 includes a third control section 31, the third communication section 32, and a third storage section 33. Since the configuration of the printing apparatus 30 is substantially the same as the configuration of the first server 10, the description of the configuration will be omitted.

For example, a program for generating detection information based on detection by a detecting section 36 including a third input/output section 34 and transmitting the detection information to the first server 10 is stored in the third storage section 33 and can be executed by the third control section 31 as described later.

The printing apparatus 30 further includes a printing section 35. The printing section 35 includes a printing mechanism (not illustrated) including, for example, a head, a transport roller, and the like.

The printing apparatus 30 may further include any one of the third input/output section 34 and the detecting section 36. In the following description, it is assumed that the printing apparatus 30 includes the third input/output section 34 and the detecting section 36 as illustrated in FIG. 1.

The third input/output section 34 including a detection panel that is a second sensor may be included in the detecting section 36 as a section that performs detection based on a user operation.

The third input/output section 34 of the printing apparatus 30 is a user interface for the user who is the person to be watched over.

The third input/output section 34 is, for example, a touch screen display. The third input/output section 34 includes a display panel which is an output section that displays various kinds of information, and the detection panel which is an input section and is the second sensor.

The detection panel is superposed on the display panel. The detection panel can detect an operation with a user's finger or the like by using a method such as a capacitive method, a resistive film method, or an optical method.

In the third input/output section 34, the input section may be a keyboard, a mouse, a button, or the like, and the output section may be a stand-type liquid crystal display or the like. Hereinafter, the input section of the third input/output section 34 is also referred to as the second sensor.

For example, detection information based on a user operation is second detection information including information indicating that the input section of the third input/output section 34 has not detected the user operation. In addition, the second detection information may include information indicating that the user has not performed an operation on the third input/output section 34 for a predetermined period of time.

The third control section 31 includes a timer and can measure a second period of time and a first period of time, which are predetermined periods of time and will be described later.

The printing apparatus 30 does not necessarily include the third input/output section 34 when the detecting section 36 to be described later is used to perform detection based on a user operation.

The printing apparatus 30 may include a tray (not illustrated) on which printed matter printed by the printing section 35 is mounted.

The detecting section 36 that is included in the printing apparatus 30 and is a first sensor can detect whether the printed matter is mounted on the tray. That is, the detecting section 36 can detect whether the user has taken out the printed matter mounted on the tray and can perform the detection based on the user operation. Hereinafter, the detecting section 36 is also referred to as the first sensor.

The detecting section 36 may use an optical sensor or a mechanical switch. The detecting section 36 may be installed in a case (not illustrated) of the printing apparatus 30 and may detect whether the printed matter is mounted on the tray.

It is preferable that the printing apparatus 30 be configured such that a tray which has the detecting section 36 and is not retractable can be retrofitted to the printing apparatus 30.

The detecting section 36 can reliably detect whether the printed matter is mounted on the tray that is not retractable. In addition, the user can replace an existing tray which does not include the detecting section 36 and is retractable with the tray according to the embodiment, and can use the tray according to the embodiment.

For example, detection information based on a user operation is first detection information including information indicating that the detecting section 36 has detected the printed matter. The first detection information may be information indicating that the detecting section 36 has continuously detected the printed matter for the first period of time or longer. Further, the first detection information may be information indicating that the user has not taken out the printed matter.

The printing apparatus 30 does not necessarily include the detecting section 36 when the above-described third input/output section 34 is used to perform detection based on a user operation.

The second server 20 is a server that serves the printing apparatus 30 as a client. The second server 20 includes a second control section 21, the second communication section 22, and a second storage section 23. Since the configuration of the second server 20 is substantially the same as the configuration of the first server 10, the description of the configuration will be omitted.

For example, a program for transmitting print information to the printing apparatus 30 is stored in the second storage section 23 and can be executed by the second control section 21 as described later.

In the second storage section 23, various kinds of content information which is print information are stored. It is assumed that a contract for distribution of the content information has been made between an administrator of the second server 20 and the user of the printing apparatus 30. The second server 20 periodically transmits the content information to the printing apparatus 30 based on the contract.

The printing apparatus 30 can periodically print the content information after receiving the content information even when no print instruction is provided from the user.

For example, the administrator of the second server 20 is a newspaper company that is also a provider of the content information, and the content information is information regarding newspaper articles. The second server 20 transmits information regarding a newspaper article to the printing apparatus 30 at a predetermined time every morning or every evening. The printing apparatus 30 receives the information regarding the newspaper article and can print the information at a fixed time. The user of the printing apparatus 30 can read the printed information regarding the newspaper article at a fixed time.

The provider of the content information may be a publisher, a municipality, or the like, and the content information may be information regarding a local publication, a circulation, or the like, in addition to a book such as a magazine or a weekly magazine.

The information processing apparatus 40 is a client that uses the first server 10 as a server for the information processing apparatus 40. The information processing apparatus 40 includes a fourth control section 41, the fourth communication section 42, and a fourth storage section 43. Since the configuration of the information processing apparatus 40 is substantially the same as the configuration of the first server 10, the description of the configuration will be omitted.

The information processing apparatus 40 may further include a fourth input/output section 44. Since the configuration of the fourth input/output section 44 of the information processing apparatus 40 is substantially the same as the configuration of the third input/output section 34 of the printing apparatus 30, the description of the configuration will be omitted.

For example, the fourth storage section 43 stores a program, such as an application that is displayed by the fourth input/output section 44 based on information received from the first server 10. The fourth control section 41 can read the application from the fourth storage section 43 and execute the application.

For example, the fourth control section 41 can display information such as a notification received from the first server 10 or a warning based on the notification on the output section of the fourth input/output section 44.

### 2. Method of Controlling Notification System

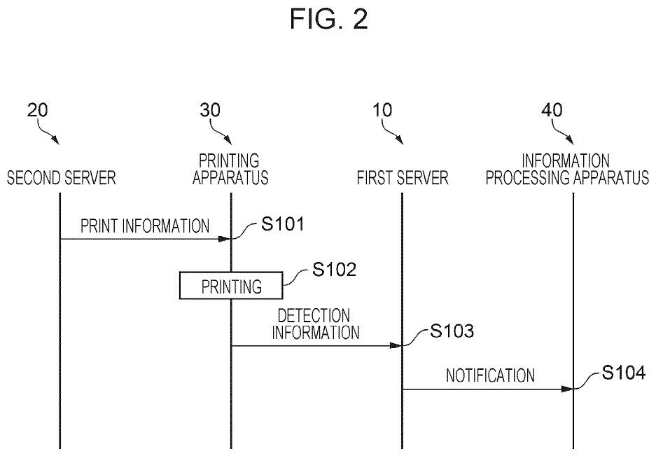

FIG. 2 illustrates a method of controlling the notification system 1 according to the embodiment. The control is executed by the second control section 21 of the second server 20, the third control section 31 of the printing apparatus 30, the first control section 11 of the first server 10, and the fourth control section 41 of the information processing apparatus 40. In the following description, the description of the fact that the control sections perform the control is omitted.

The second server 20 periodically transmits print information to the printing apparatus 30 (S101), and the printing apparatus 30 prints the received print information (S102).

The printing apparatus 30 generates, after printing the print information, detection information based on a user operation and transmits the detection information to the first server 10 (S103). The detection information is information based on detection by the detecting section 36 including the third input/output section 34. The first server 10 transmits a notification to the information processing apparatus 40 based on the received detection information (S104). The information processing apparatus 40 can display the received notification.

After receiving the above-described first detection information as the detection information from the printing apparatus 30, the first server 10 can transmit the first detection information as a notification to the information processing apparatus 40. The information processing apparatus 40 can cause the output section of the fourth input/output section 44 to display the first detection information.

The first detection information may be information indicating that the user has not taken out the printed matter for the first period of time or longer after the printing of the content information or the like by the printing apparatus 30.

Based on the received first detection information, the first server 10 may generate, as a notification, warning information indicating that there is a possibility that the behavior state of the user is abnormal, and may transmit the warning information to the information processing apparatus 40. The information processing apparatus 40 can cause the fourth input/output section 44 to display the received warning information.

The information processing apparatus 40 that has received the first detection information as a notification may generate warning information and cause the fourth input/output section 44 to display the warning information.

Similarly, after receiving the above-described second detection information as the detection information from the printing apparatus 30, the first server 10 can transmit the second detection information as a notification to the information processing apparatus 40. The information processing apparatus 40 can cause the fourth input/output section 44 to display the second detection information.

As described above, for example, the second detection information is information indicating that the user has not operated the third input/output section 34 for the second period of time or longer after the printing of the content information or the like by the printing apparatus 30.

Based on the received second detection information, the first server 10 may generate, as a notification, warning information indicating that there is a possibility that the behavior state of the user is abnormal, and transmit the warning information to the information processing apparatus 40. The information processing apparatus 40 can cause the fourth input/output section 44 to display the warning information.

The information processing apparatus 40 that has received the second detection information as a notification may generate warning information and cause the fourth input/output section 44 to display the warning information.

In this way, the first server 10 can transmit the warning information, that is, can perform so-called push notification even when no inquiry is provided from the information processing apparatus 40.

When the third input/output section 34 detects a user operation in less than the second period of time after the printing apparatus 30 prints content information or the like, the printing apparatus 30 may generate, as detection information, third detection information indicating that the user operation has been performed, and may transmit the third detection information to the first server 10.

Similarly, the printing apparatus 30 may transmit the third detection information to the first server 10 also when the detecting section 36 changes from a state in which the detecting section 36 detects the printed matter to a state in which the detecting section 36 does not detect the printed matter in less than the first period of time after printing. Note that the case where the detecting section 36 of the printing apparatus 30 changes from the state in which the detecting section 36 detects the printed matter to the state in which the detecting section 36 does not detect the printed matter is the case where the user takes out the printed matter from the tray.

The first server 10 can transmit the received third detection information as a notification to the information processing apparatus 40. The information processing apparatus 40 can generate no-abnormality information indicating that the behavior state of the user is not abnormal, based on the received third detection information, and cause the fourth input/output section 44 to display the no-abnormality information.

The first server 10 can also generate the no-abnormality information based on the received third detection information and transmit the non-abnormality information as a notification to the information processing apparatus 40. The information processing apparatus 40 can cause the fourth input/output section 44 to display the received no-abnormality information.

When the first server 10 receives the third detection information, the first server 10 may store the third detection information or the no-abnormality information in the first storage section 13 without transmitting the third detection information or the no-abnormality information to the information processing apparatus 40. When the first server 10 receives an inquiry from the information processing apparatus 40 at any time, the first server 10 can read the third detection information or the no-abnormality information from the first storage section 13 and transmit the read information to the information processing apparatus 40.

In this way, when the first server 10 receives an inquiry from the information processing apparatus 40, the first server 10 can transmit the third detection information or the no-abnormality information, that is, can perform so-called pull notification.

The third detection information and the no-abnormality information may include information indicating a date and time when the third input/output section 34 has detected the user operation. In addition, the third detection information and the no-abnormality information may include information indicating a date and time when the detecting section 36 has changed from a state in which the detecting section 36 has detected the printed matter to a state in which the detecting section 36 has not detected the printed matter.

The information processing apparatus 40 can cause the fourth input/output section 44 to display the date and time information regarding the operation performed by the user on the printing apparatus 30. The client can know the behavior state of the user regarding the printing apparatus 30 by using the information processing apparatus 40.

The notification system 1 may include a plurality of information processing apparatuses 40, and for example, a person other than the client may possess the information processing apparatuses 40. The first server 10 can transmit the detection information, the warning information, the no-abnormality information, and the like to the plurality of information processing apparatuses 40.

The printing apparatus 30 may include a scanner (not illustrated), and in this case, the notification system 1 does not necessarily include the second server 20.

The printing apparatus 30 can perform scanning, copying, faxing, and the like using the scanner in response to an instruction from the user who uses the printing apparatus 30 on a daily basis. The printing apparatus 30 can cause the third input/output section 34 or the detecting section 36 to perform detection for scanning, copying, faxing, and the like. The printing apparatus 30 can generate detection information based on the detection and can transmit the detection information to the first server 10.

In addition, the notification system 1 does not necessarily include the second server 20 when the printing apparatus 30 performs printing alone in response to an instruction from the user who uses the printing apparatus 30 on a daily basis. The same applies to a case where, instead of the second server 20, a computer (not illustrated) connected to the printing apparatus 30 transmits print information such as a document to the printing apparatus 30 and causes the printing apparatus 30 to print the print information.

### 3. Method of Controlling Printing Apparatus

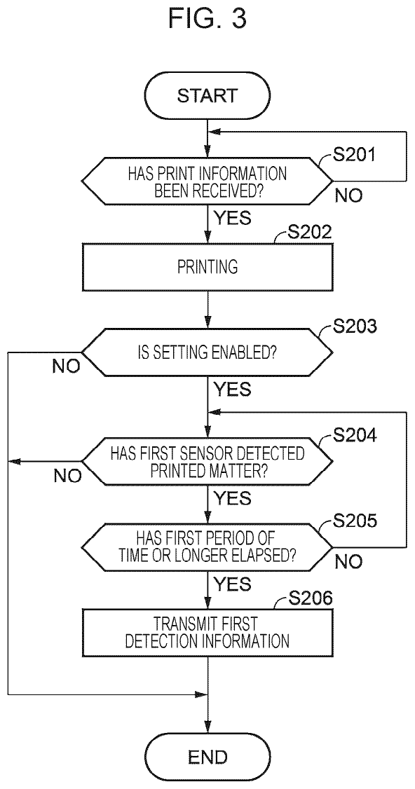

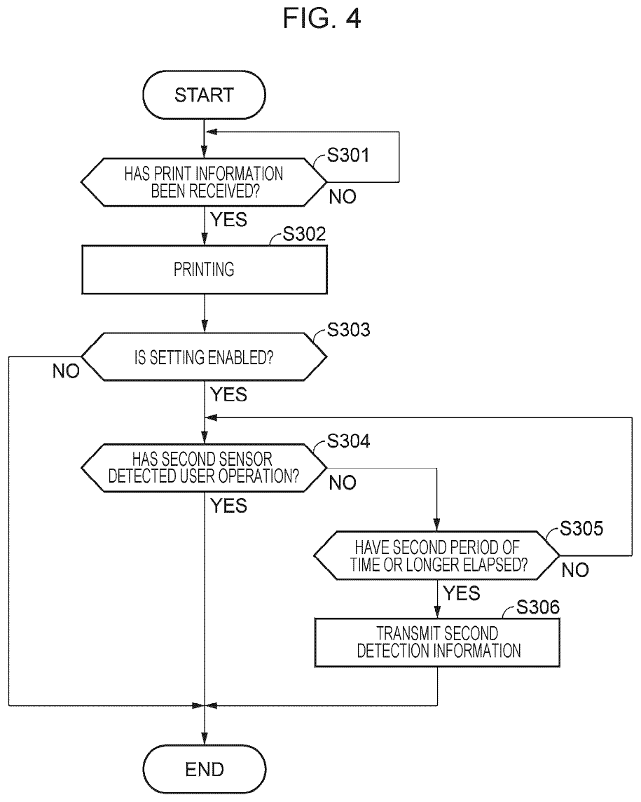

A method of controlling the printing apparatus 30 according to the embodiment will be described with reference to FIGS. 3 and 4. FIG. 3 illustrates control in which the third control section 31 of the printing apparatus 30 generates first detection information based on a detection result of the detecting section 36 which is the first sensor, and transmits the first detection information to the first server 10. FIG. 4 illustrates control in which the third control section 31 generates second detection information based on a detection result of the input section of the third input/output section 34 which is the second sensor, and transmits the second detection information to the first server 10.

First, a control method of the third control section 31 of the printing apparatus 30 will be described with reference to FIG. 3 illustrating the control regarding the first sensor. In the following description, the third control section 31 of the printing apparatus 30 executes each type of control. However, for the sake of simplicity, the third control section 31 is simply referred to, and the wording “printing apparatus 30” is omitted.

The third control section 31 determines whether print information has been received from the second server 20 (S201). The third control section 31 waits until the print information is received (S201: NO). When the print information is received (S201: YES), the third control section 31 causes the printing section 35 to print the print information (S202). The timer of the third control section 31 starts to measure time.

In this case, the third control section 31 may cause the output section of the third input/output section 34 to display an instruction for the user to take out the printed matter mounted on the tray.

In the third storage section 33 of the printing apparatus 30, setting information regarding a setting for enabling or disabling transmission of detection information to the first server 10 is stored. The setting information can be input by the user through the third input/output section 34 of the printing apparatus 30 and can be stored in the third storage section 33.

For example, when the user is absent for several days due to a trip or the like, the user can disable the setting by using the third input/output section 34. The user may enable the setting when the user returns from the trip, for example.

The setting information may include disabling period information indicating that the setting is disabled for a predetermined period. The user can enable the setting, input the disabling period information, and store the disabling period information to the third storage section 33 by using the third input/output section 34.

The third control section 31 reads the setting information and the disabling period information included in the setting information from the third storage section 33, and compares the read information with the time measured by the timer. When the measured time is in the period corresponding to the disabling period information, the third control section 31 determines that the setting is disabled even in a state in which the setting is enabled. On the other hand, when the measured time is not in the period corresponding to the disabling period information, the third control section 31 determines that the setting is enabled as set.

In this way, the third control section 31 can determine whether the setting is enabled or disabled, based on the setting information and the disabling period information included in the setting information.

In addition to the printing apparatus 30, the information processing apparatus 40 can also set the setting in the printing apparatus 30 by using an application via the WAN 50.

The third control section 31 may delete the disabling period information in the third storage section 33 when the predetermined period for which the setting is disabled elapses. In this case, the third control section 31 leaves the setting information indicating the enabled or disabled setting without deleting the setting information.

The third control section 31 reads the setting information from the third storage section 33, and determines whether the setting is enabled (S203).

When the third control section 31 determines that the setting is not enabled and is disabled (S203: NO), the third control section 31 ends the process. The third control section 31 does not transmit detection information to the first server 10.

On the other hand, when the third control section 31 determines that the setting is enabled (S203: YES), the third control section 31 determines whether the first sensor which is the detecting section 36 has detected the printed matter mounted on the tray (S204).

When the third control section 31 determines that the first sensor has detected the printed matter (S204: YES), the third control section 31 determines whether the first period of time or longer has elapsed by using the timer after the printing of the print information (S205).

When the third control section 31 determines that the first period of time or longer has not elapsed (S205: NO), the third control section 31 waits until the first period of time or longer elapses while determining whether the first sensor has detected the printed matter (S204).

When the third control section 31 determines that the first sensor has continuously detected the printed matter (S204: YES) and that the first period of time or longer has elapsed (S205: YES), the third control section 31 generates the first detection information, transmits the first detection information to the first server 10 (S206), and ends the process.

The case where the first detection information is transmitted is the case where the first sensor of the printing apparatus 30 detects the printed matter for the first period of time or longer. The third control section 31 can determine that the user has not taken out the printed matter from the tray for the first period of time or longer.

As described above, the first detection information may be information indicating that the first sensor has detected the printed matter for the first period of time or longer. Further, the first detection information may be information indicating that the user has not taken out the printed matter from the tray.

On the other hand, when the third control section 31 determines that the first sensor has not detected the printed matter (S204: NO), the third control section 31 ends the process.

In this case, the detecting section 36 of the printing apparatus 30 changes from a state in which the detecting section 36 detects the printed matter to a state in which the detecting section 36 does not detect the printed matter before the first period of time elapses. The third control section 31 can determine that the user has taken out the printed matter from the tray before the first period of time elapses.

Next, a control method of the third control section 31 of the printing apparatus 30 will be described with reference to FIG. 4 illustrating the control regarding the second sensor which is the input section of the third input/output section 34.

The third control section 31 determines whether print information has been received from the second server 20 (S301). The third control section 31 waits until the print information is received (S301: NO). When the print information is received (S301: YES), the third control section 31 causes the printing section 35 to print the print information (S302). The timer of the third control section 31 starts to measure time.

The third control section 31 causes the output section of the third input/output section 34 to display instruction information for prompting the user to take out the printed matter mounted on the tray.

Further, the third control section 31 causes the output section of the third input/output section 34 to display instruction information for prompting the user to input, into the input section of the third input/output section 34, information indicating that the user has taken out the printed matter after the taking out of the printed matter from the tray.

The user can visually check the printed matter printed by the printing apparatus 30 and mounted on the tray, visually check the instruction information displayed on the output section of the third input/output section 34, take out the printed matter from the tray, and operate the input section of the third input/output section 34.

A speaker may be provided in the output section of the third input/output section 34 of the printing apparatus 30 to notify the user of the instruction information by voice or the like.

The third control section 31 reads the setting information from the third storage section 33 and determines whether the setting is enabled (S303).

When the third control section 31 determines that the setting is not enabled and is disabled (S303: NO), the third control section 31 ends the process. The third control section 31 does not transmit detection information to the first server 10.

On the other hand, when the third control section 31 determines that the setting is enabled (S303: YES), the third control section 31 determines whether the second sensor has detected a user operation, which is an input indicating that the user has taken out the printed matter from the tray (S304).

When the third control section 31 determines that the second sensor has detected the user operation (S304: YES), the third control section 31 ends the process. In the end of the process, the third control section 31 deletes the instruction information displayed on the third input/output section 34.

In this case, the input section of the third input/output section 34 detects the input indicating that the user has taken out the printed matter from the tray before the second period of time to be described later has elapsed. The third control section 31 can determine that the user has taken out the printed matter.

Even when the user does not take out all of the printed matter mounted on the tray and even one sheet of the printed matter remains on the tray, the third control section 31 can use the third input/output section 34 to determine that the user has taken out the printed matter.

On the other hand, when the third control section 31 determines that the second sensor has not detected the user operation (S304: NO), the third control section 31 then determines whether the second period of time or longer has elapsed by using the timer after the printing of the print information (S305).

When the third control section 31 determines that the second period of time or longer has not elapsed (S305: NO), the third control section 31 waits until the second period of time or longer elapses while determining whether the second sensor has detected the user operation (S304).

When the third control section 31 determines that the second sensor has not continuously detected the user operation (S304: NO) and that the second period of time or longer has elapsed (S305: YES), the third control section 31 generates the second detection information, transmits the second detection information to the first server 10 (S306), and ends the process. In the end of the process, the third control section 31 may delete the instruction information displayed on the third input/output section 34.

The second detection information is transmitted when the third input/output section 34 of the printing apparatus 30 does not detect the user operation for the second period of time or longer. The third control section 31 can determine that the user has not taken out the printed matter from the tray.

As described above, the second detection information may be information indicating that the third input/output section 34 has not detected the user operation for the second period of time or longer. Further, the second detection information may be information indicating that the user has not taken out the printed matter.

As described above, the notification system 1 which is the watching system according to the embodiment includes the first server 10, the printing apparatus 30, and the information processing apparatus 40. The printing apparatus 30 is capable of transmitting detection information based on a user operation to the first server 10 after printing print information. The first server 10 is capable of transmitting a notification to the information processing apparatus 40 based on the received detection information.

According to the notification system 1 described above, it is possible to cope with the daily life of the person to be watched over, a dedicated device is not required, and thus the convenience is high.

The printing apparatus 30 according to the embodiment is capable of communicating with the first server 10 and includes the printing section 35 that prints print information, the detecting section 36 that performs detection based on a user operation, and the third control section 31 that, after the printing of the print information by the printing section 35, is capable of generating detection information based on the detection by the detecting section 36 and transmitting the detection information to the first server 10. The detecting section 36 may include the third input/output section 34.

According to the printing apparatus 30 described above, it is possible to cope with the daily life of the person to be watched over and the convenience is high.

The method of controlling the printing apparatus 30 according to the embodiment that is capable of communicating with the first server 10 and includes the printing section 35 that prints print information and the detecting section 36 that performs detection based on a user operation includes, after the printing of the print information by the printing section 35, generating detection information based on the detection by the detecting section 36 and transmitting the detection information to the first server 10. The detecting section 36 may include the third input/output section 34.

According to the method of controlling the printing apparatus 30 described above, it is possible to cope with the daily life of the person to be watched over and the convenience is high.

As described above, the embodiments have been described in detail with reference to the drawings, but the specific configurations are not limited to the configurations described in these embodiments, and changes, replacement, removal, and the like may be made without departing from the gist of the present disclosure.

For example, the first server 10 may have the function of the second server 20 that transmits the print information. In this case, the notification system 1 may exclude the second server 20.

In addition, the third control section 31 of the printing apparatus 30 may sequentially transmit, as status information, a detection result of the first sensor which is the detecting section 36 to the first server 10, and the first control section 11 of the first server 10 may determine the detection result of the first sensor. Further, the first control section 11 of the first server 10 may include a timer to measure time, and determine whether the first period of time or longer has elapsed.

Instead of the printing apparatus 30, the first control section 11 of the first server 10 can determine that the detecting section 36 of the printing apparatus 30 has detected the printed matter for the first period of time or longer. The first control section 11 can determine that the user has not taken out the printed matter from the tray. In this case, the first server 10 can notify the information processing apparatus 40 that the user has not taken out the printed matter from the tray.

Similarly, the third control section 31 of the printing apparatus 30 may sequentially transmit, as status information, a detection result of the second sensor which is the input section of the third input/output section 34 to the first server 10, and the first control section 11 of the first server 10 may determine the detection result of the second sensor. Further, the first control section 11 of the first server 10 may include a timer to measure time and determine whether the second period of time or longer has elapsed.

Instead of the printing apparatus 30, the first control section 11 of the first server 10 can determine that the third input/output section 34 of the printing apparatus 30 has not detected the user operation for the second period of time or longer. In this case, the first control section 11 can determine that the user has not taken out the printed matter from the tray. The first server 10 can notify the information processing apparatus 40 that the user has not taken out the printed matter from the tray.

What is claimed is:

1. A watching system comprising a first server, a printing apparatus, and an information processing apparatus, wherein
the printing apparatus is capable of transmitting detection information based on a user operation to the first server after printing print information, and
the first server is capable of transmitting a notification to the information processing apparatus based on the received detection information.

2. The watching system according to claim 1, further comprising a second server that transmits content information as the print information, wherein
the printing apparatus is capable of transmitting the detection information to the first server after printing the content information received from the second server.

3. A printing apparatus capable of communicating with a first server, the printing apparatus comprising:
a printing section that prints print information;
a detecting section that performs detection based on a user operation; and
a control section that, after the printing of the print information by the printing section, is capable of generating detection information based on the detection by the detecting section and transmitting the detection information to the first server.

4. The printing apparatus according to claim 3, wherein
the first server is capable of transmitting a notification to an information processing apparatus based on the detection information,
the print information is content information received from a second server, and
the control section is capable of transmitting the detection information to the first server after the printing section prints the content information received from the second server.

5. The printing apparatus according to claim 3, wherein
the detecting section is a first sensor capable of detecting printed matter printed by the printing section, and
when the first sensor continuously detects the printed matter for a first period of time or longer after the printing of the print information by the printing section, the control section transmits first detection information as the detection information to the first server.

6. The printing apparatus according to claim 3, wherein
the detecting section is a second sensor capable of detecting the user operation, and
when the second sensor does not detect the user operation for a second period of time or longer after the printing of the print information by the printing section, the control section transmits second detection information as the detection information to the first server.

7. A method of controlling a printing apparatus that is capable of communicating with a first server and includes a printing section that prints print information and a detecting section that performs detection based on a user operation, the method comprising: after the printing of the print information by the printing section,
generating detection information based on the detection by the detecting section and transmitting the detection information to the first server.

8. The method according to claim 7, wherein
the first server is capable of transmitting a notification to an information processing apparatus based on the detection information,
the print information is content information received from a second server, and
the detection information is transmitted to the first server after the printing section prints the content information received from the second server.
